(19) United States
(12) Patent Application Publication
(10) Pub. No.: US 2006/0005779 A1
(43) Pub. Date: Jan. 12, 2006

(54) Lifetime bird sanctuary

(76) Inventor: Gary Stehley, Altoona, PA (US)

Correspondence Address: Dwight G. Diehl, 117 South Juliana Street, Bedford, PA, 15522, US

(21) Appl. No.: 10/886,131

(22) Filed: Jul. 8, 2004

(51) Int. Cl. A01K 31/14

(52) U.S. Cl. 119/428

(57) ABSTRACT

The present invention deals with single and multiple unit, bird sanctuaries, made from plastic pipe. The bird sanctuaries are easily mounted to the ground or hung from a cable and can be disassembled to be cleaned from one year to the next to provide for a clean sanctuary for birds the following year.

### BACKGROUND OF THE INVENTION

It is well known to construct birdhouses or sanctuaries such that either singular homes or multiple homes can be combined. It is well known in the art that multiple bird housing has been constructed and structured to resemble buildings, ships, motels, and such, having multiple entries and compartments providing multiple homes for multiple bird families. However, the prior art housing or structures for birds have required painting and regular maintenance to insure the integrity of the structures as well as the appearance thereof. Further, it is difficult to clean out the prior art bird housing structures.

### BRIEF DESCRIPTION

The present invention provides for economical housing structures that require little or no maintenance as well as provide for the ease of cleaning the birdhouse structures. The present invention constructs either single or multiple bird sanctuaries out of plastic pipe, commonly known as PVC pipe, that can be readily connected together to form singular or multiple housing compartments for birds.

### BRIEF DESCRIPTION OF THE DRAWINGS

FIG. 1 shows a single unit bird sanctuary according to the present invention;

FIG. 2 shows a multiple unit bird sanctuary which can be mounted stationary or hung on a cable;

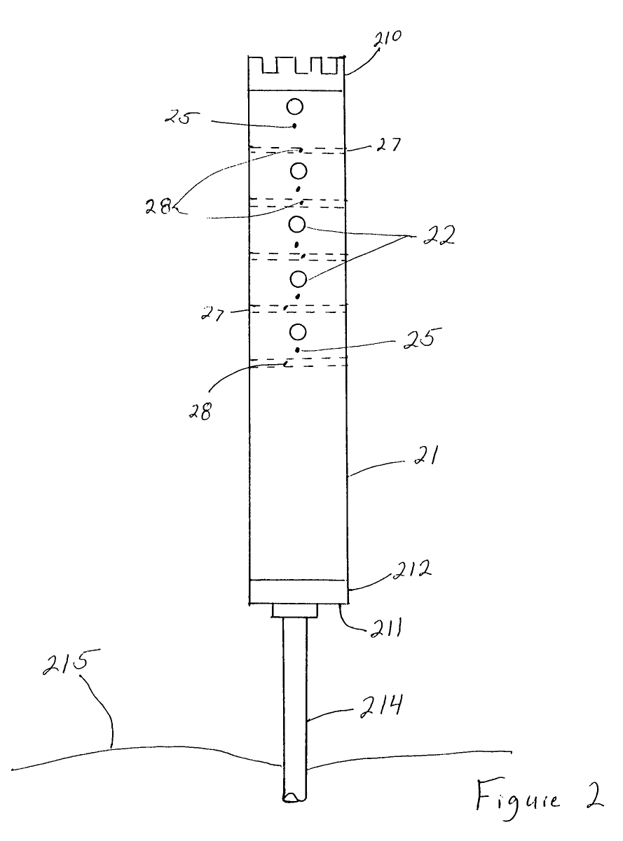

FIG. 3 shows a multiple unit partially cut away;

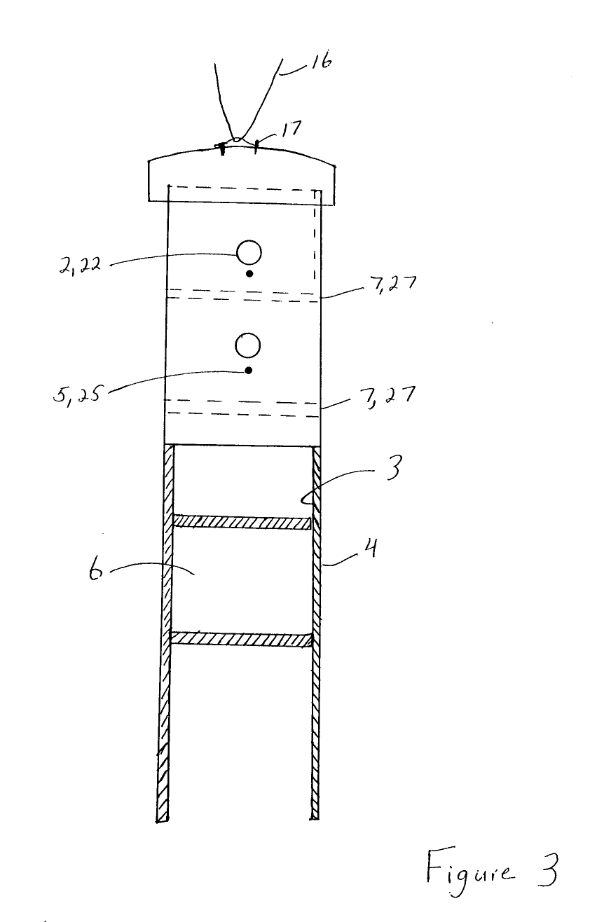

FIG. 4 shows an alternative design for a multiple unit bird sanctuary; and

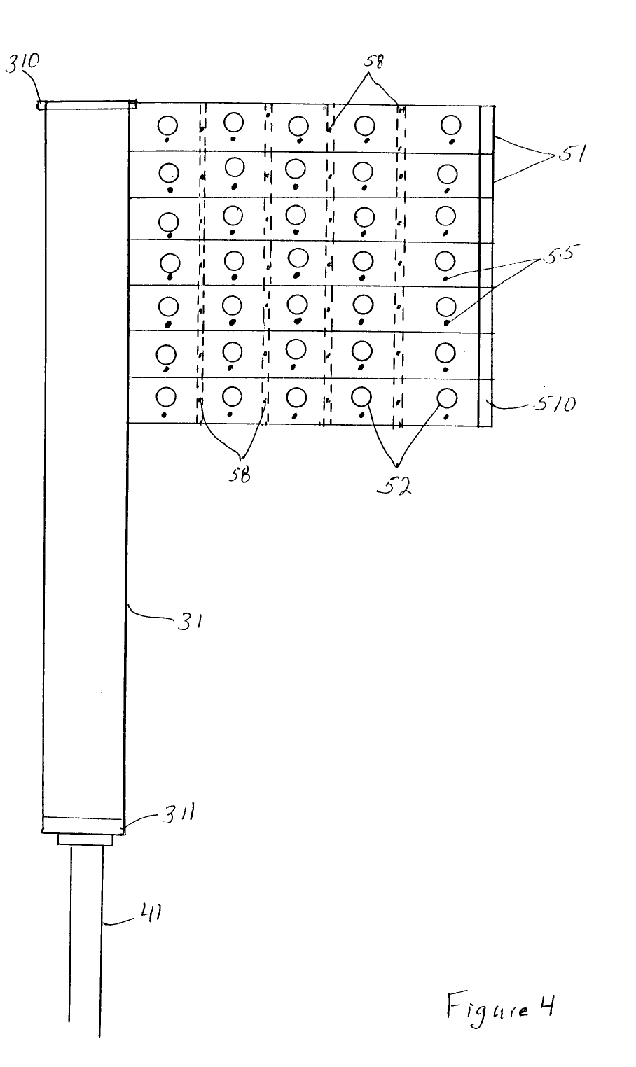

FIG. 5 shows a third embodiment of a multiple unit bird sanctuary.

### DETAILED DESCRIPTION

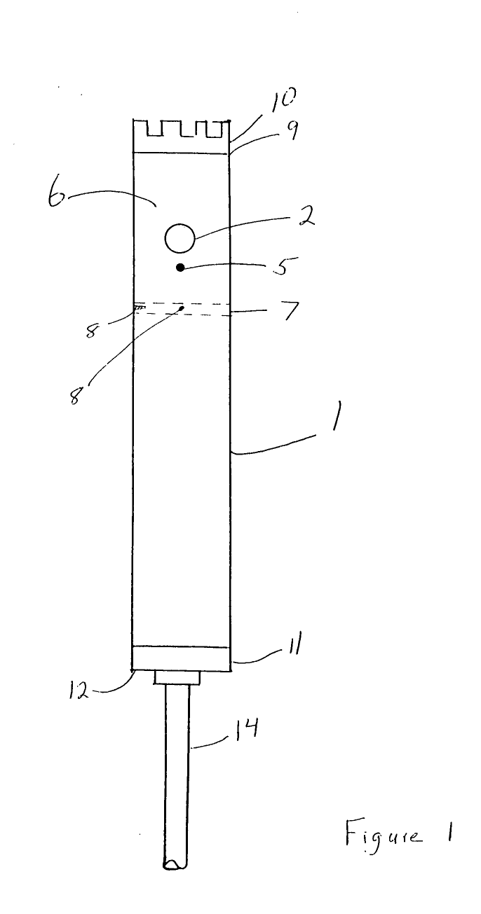

The present invention utilizes plastic pipe or what is more commonly called PVC pipe to construct bird housing compartments. The simplest of designs of the present invention involves a piece of plastic pipe 1 having a diameter of 6 inches. To construct the birdhouse within this pipe 1, one would drill a hole or holes 2 in the side of the pipe allowing access to the interior 3 by the bird. On the exterior 4 of the pipe 1 immediately below the hole 2 would be inserted a dowel rod 5 that would allow the bird to land on the rod 5 before entering the hole 2 to the interior 3 of the pipe 1. The interior compartment 6 is constructed with a plywood divider 7 that has been inserted into the pipe 1 and held in place by four stainless steel screws 8. The divider 7 is cut to fit the interior dimensions of the pipe 1, slid into one end 9 or 12 of the pipe and located below the entry hole 2. The plywood divider 7 is held in place by the four stainless steel screws 8 as shown in the FIG. 1. Once the plywood divider 7 is in place, an end cap 10 is placed on the top of the pipe 9, and a second end cap 11 is placed on the bottom of the pipe 12. Once the home is constructed in this manner one can now attach the home to a second pipe 14 by means of the second or lower end cap 11 with the second pipe 14 placed in the ground 15. This provides a standing bird sanctuary that can be readily mounted at any location the owner desires. An alternative would be to attach a cable 16 to the pipe 1 by means of stainless steel screws 17 and a bracket 18, thus the cable 16 providing for a hanging bird sanctuary. This simple design can thus provide for a stationary bird sanctuary or a hanging, swinging bird sanctuary.

The above design can be further expanded to provide for multiple compartments within a singular piece of plastic pipe 21. One would simply use a longer section of 6-inch plastic pipe 21 and would drill or cut multiple entry holes 22 at a fixed distance apart over the length of the plastic pipe 21. Below each of these entry holes 22 would be inserted a dowel rod 25 on which the bird can alight when entering it's compartment. Each compartment will be divided by a platform or plywood divider 27 inserted from one end 29 or 212 of the plastic pipe 21. Each plywood divider 27 will be held in place by stainless steel screws 28. Beginning at one end and progressing toward the other, one can insert the multiple dividers 27 needed to divide the pipe 21 into multiple compartments, for bird housing. Once all the platforms 27 are in place end caps 210 and 211 are then installed on the end of the pipe and the lower end is attached to a second piece of plastic pipe 214 which is mounted in the ground 215. Upon mounting the first piece of pipe 21 on the second pipe 214, a multiple bird-housing complex has now been formed out of the plastic pipe rendering it basically indestructible and requiring little or no maintenance. Both of the foregoing designs are constructed so that they may be cleaned out by removing one of the end caps 10, 11, 210 or 211. After the end cap is removed, one would remove the stainless steel screws 8 or 28 holding the divider or dividers 7, 27 in place, and would simply remove the platforms 7 or 27 through the end on which the cap has been removed. Having done this, all former nesting material or other items taken into the interior of the pipe or the compartments by a bird would be removed. One simply would then reinstall each of the dividers 7 or 27 and the screws 8 or 28 and when done, the end cap, would be replaced to again have a clean useful bird-housing structure available for the next season.

The preferred embodiment as described above would provide a bird sanctuary in the form of what could commonly be called a totem pole design. However, many alternatives are possible and a few of which will be described herein. One alternative is to install one 6-foot piece of 6-inch plastic pipe 31 onto the end of a 2-inch piece of pipe 41 planted firmly in the ground. The 6-foot 6-inch pipe 31 would extend vertically from the ground. At the top of the 6-inch pipe would be a series of horizontal rows of 4-inch plastic pipe 51, shown in the figure. These horizontal rows of 4-inch plastic pipe 51 will be inserted into or attached to the vertical 6-inch pipe 31. The 4-inch pipe 51 would be stacked one on top another and would extend a distance in the horizontal distance from the vertical pipe 31. Each of these horizontal pipes 51 would contain five entry holes 52 each with a dowel pin 55 located immediately there below to allow a bird to alight on the dowel rod 55 before entering the entrance hole 52. Each entrance hole 52 would again be separated by a piece of plywood or divider 57 held in place by a series of stainless steel screws 58. This would provide for five separate bird-housing units in each of the 4-inch plastic pipe 51. Each horizontal pipe as well as the vertical pipe would have an end cap 310, 311, 510 placed thereon to prevent the elements or anything else from entering into the pipe 31 or 51. Again, to clean these 4-inch pipes 51, one would simply remove them from the 6-inch pipe 31, remove the screws 58 to allow the divider 57 to be removed once the end cap 510 is removed. Once the pipe 51 was cleaned, the divider 57 would be reinstalled, the end caps 510 returned and the 4-inch pipe 51 again attached to the 6-inch pipe 31. An alternative design to this is that every other pipe 51 could be painted a different color. In this example the top one could be red, the second one white and the third one blue and would simply alternate from there down forming a patriotic symbol while providing perpetual bird sanctuaries.

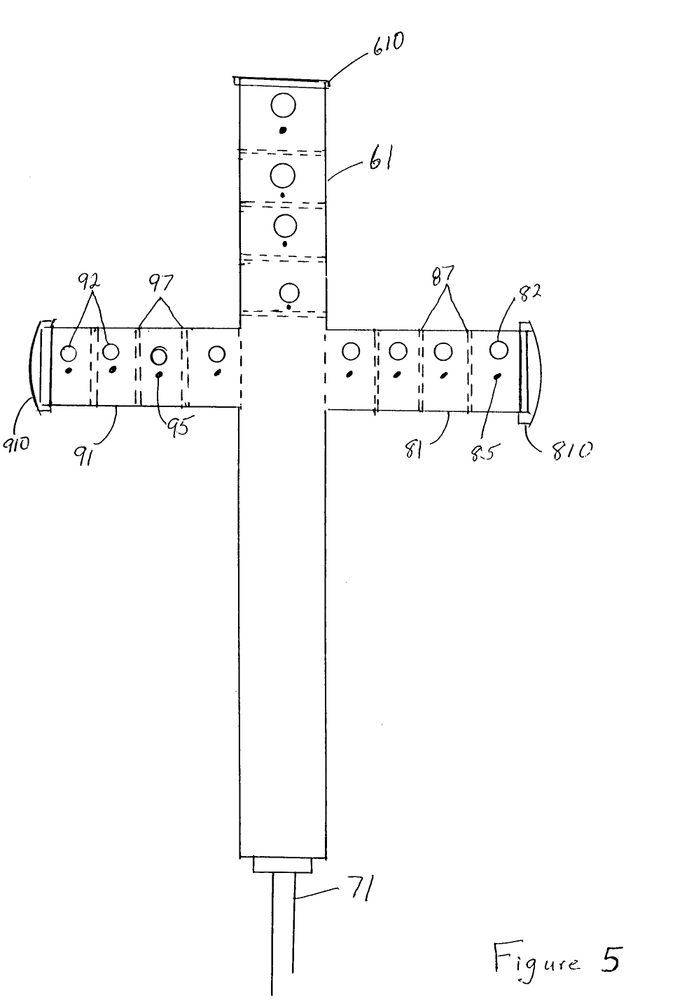

Another alternative as shown in FIG. 5 would be a cross design. This would entail a 6-inch piece of pipe 61 being connected to a 2-inch pipe 71 firmly planted in the ground. A vertical distance from the ground on the 6-inch plastic pipe 61, 2-foot 6-inch pieces of plastic pipe 81 and 91 would be attached to the vertical pipe 61 and would extend horizontally therefrom in opposite directions located 180° apart from each other. Each of these horizontal pipes 81 and 91 would contain dowel rods 85 and 95 located immediately below four entry holes 82 and 92. Each of the entry holes would be separated again by a divider 87, 97 respectively, held in place by stainless steel screws 88, 98 respectively, thus sectioning the horizontal pipes 81 and 91 into four individual units. The portion of pipe 61 that would extend above the horizontal pieces 81 and 91 would also contain five entry holes 62 and dowel rods 65 located immediately below the entry holes 62 and each of these holes 62 would be separated by plywood dividers 67 held in place by stainless steel screws 68 through the plastic pipes 61. An end cap 610 is placed on the top 69 of pipe 61. End caps 810 and 910 are located on pipes 81 and 91 respectfully as shown in FIG. 5.

These designs are merely illustrative of the multiple designs one could use when utilizing the inventive concepts of the present invention. While only four designs have been described in detail herein, a multitude of alternative designs could readily be used without deviating from the inventive concept of the present invention and are deemed obvious to one of ordinary skill in the art. Further, the preferred embodiment uses plastic pipe, however, other weather proof tubing, cylindrical or other shape, could be utilized and would be recognized by one of ordinary skill in the art, not to deviate from the inventive concept of the present invention.

The entry holes 2, 22, 52, 82, and 92 can be various sizes as well as the dowel rods. The size of the bird utilizing the bird sanctuary can be somewhat controlled by the size of the hole and the dowel rod perch.

Varying the size of the plastic pipe and the spacing between the platforms, one can also monitor and control the size of the bird that utilizes the present invention.

I claim:

1. A bird sanctuary comprising: a first hollow tube; at least 1 entry hole in said hollow tube; a bird perch on said first hollow tube; a removable interior divider attached inside said first hollow tube; closure means for each end of said hollow tube; and a mounting means for mounting said hollow tube.

2. A bird sanctuary as recited in claim 1 further comprising: multiple entry holes in said hollow tube; multiple bird perches; and multiple removable interior dividers.

3. A bird sanctuary as recited in claim 2 further comprising: said mounting means comprises a second hollow tube connected to a lower end of said first hollow tube and said second hollow tube is mounted in the ground.

4. A bird sanctuary as recited in claim 2 further comprising: said mounting means comprises a cable attached to an upper end of said first hollow tube

5. A bird sanctuary as recited in claim 1 further comprising: a second hollow tube; a third hollow tube; said second hollow tube and said third hollow tube each attached to said first hollow tube; said first hollow tube extending in a vertical direction and said second hollow tube and said third hollow tube each extending horizontally from said first hollow tube and located on opposite sides of said first hollow tube from each other; said first hollow tube having a plurality of entry holes; said first hollow tube having a plurality of removable interior dividers; said first hollow tube having a plurality of said bird perches; said second hollow tube having a plurality of entry holes; said second hollow tube having a plurality of removable interior dividers; said second hollow tube having a plurality of bird perches; said third hollow tube having a plurality of entry holes; said third hollow tube having a plurality of removable interior dividers; and said third hollow tube having a plurality of bird perches.

6. A bird sanctuary comprising: a vertical hollow tube; closure means for each end of said vertical hollow tube; a plurality of horizontal hollow tubes; a plurality of entry holes in each of said horizontal hollow tubes; a plurality of bird perches mounted in each said horizontal hollow tubes; a plurality of removable interior dividers located on the interior of each said horizontal hollow tubes; each of said horizontal hollow tubes attached at one end to said vertical hollow tube, such that said horizontal hollow tubes are located one on top of the other as they are attached to said vertical hollow tube; means for closing said horizontal hollow tubes at an end opposite to the end attached to said vertical hollow tube; and a mounting means attached to said vertical hollow tube.
